(19) United States
(12) Patent Application Publication
(10) Pub. No.: US 2017/0199442 A1
(43) Pub. Date: Jul. 13, 2017

(54) HEAD-MOUNTED DEVICE AND DISPLAY DEVICE

(71) Applicant: Samsung Display Co., Ltd., Yongin-si (KR)

(72) Inventors: Kiseo Kim, Gongju-si (KR); Jae-kyoung Kim, Goyang-si (KR); Seockhwan Kang, Seoul (KR)

(21) Appl. No.: 15/252,035

(22) Filed: Aug. 30, 2016

(30) Foreign Application Priority Data
Jan. 8, 2016 (KR) 10-2016-0002746

(51) Int. Cl. G02F 1/31; G02B 27/01; G02B 26/00; G02B 27/02; G02B 26/08

(52) U.S. Cl. CPC G02F 1/31; G02B 27/022; G02B 26/0875; G02B 26/004; G02B 27/0172; G02F 2001/294

(57) ABSTRACT

A head-mounted device includes a case part including a body part, a cover part adapted to cover at least a portion of the body part, and a space for mounting a display panel between the body part and the cover part. The optical system is positioned in the body part to face the cover part and has a focal point that has a position which is periodically changed.

### CROSS-REFERENCE TO RELATED APPLICATION

This application claims priority to and the benefit of Korean Patent Application No. 10-2016-0002746, filed on Jan. 8, 2016, the entire contents of which are hereby incorporated by reference.

### BACKGROUND

The present disclosure herein relates to a head-mounted device and a display device, and more particularly, to a head-mounted device and a display device which have improved display quality.

A head-mounted device is a device worn on the head and may include a display panel unit or may be coupled to the display panel unit. The head-mounted device may be used to realize augmented reality or virtual reality. The head-mounted device for realizing augmented reality may provide a virtual graphic image through a semi-transparent display. In this case, a user may simultaneously view a virtual graphic image and an actual object. The head-mounted device for realizing virtual reality may provide the user's eye with a virtual graphic image. The user may experience virtual reality through virtual contents.

### SUMMARY

The present disclosure provides a head-mounted device and a display device which have improved display quality.

An embodiment of the inventive concept provides a head-mounted device, which includes: a case part including a body part and a cover part configured to cover at least a portion of the body part, wherein a space for mounting a display panel unit (or display panel) is between the body part and the cover part; and an optical system positioned in the body part to face the cover part and having a focal point having a position which is periodically changed.

In an embodiment, the optical system may be spaced apart from the cover part in a first direction, and the position of the focal point may be periodically changed between a first point and a second point spaced apart from the first point in the first direction.

In an embodiment, a number of times that the position of the focal point is moved from the first point to the second point for about one second and then returns to the first point may be greater than a critical fusion frequency (CFF).

In an embodiment, a number of times that the position of the focal point is moved from the first point to the second point for about one second and then returns to the first point may be changeable according to a user request.

In an embodiment, the optical system may be adapted to reciprocate in a direction parallel to the first direction.

In an embodiment, while the optical system reciprocates, a focal length of the optical system may be invariant.

In an embodiment, a focal length of the optical system may be periodically changed.

In an embodiment, the optical system may be adapted to contract and expand such that a thickness thereof in the first direction is changed.

In an embodiment, the optical system may include an electroactive polymer having a shape which is deformed when a voltage is applied to the electroactive polymer.

In an embodiment, the optical system may include a film and a fluid in the film, wherein a thickness of the optical system in the first direction may be changeable by adjusting the amount of the fluid.

In an embodiment, a refractive index of the optical system may be periodically changed.

In an embodiment, the optical system may include a plurality of liquid crystal molecules having varying orientation directions, wherein the refractive index of the optical system may be changed according to the orientation directions of the liquid crystal molecules.

In an embodiment, the head-mounted device may further include a display panel in the space for mounting the display panel and the display panel may be configured to provide an image.

In an embodiment, when the position of the focal point is at any one of the first point and the second point, the image may be focused.

In an embodiment, when the position of the focal point is at one point between the first point and the second point, the image may be focused.

In an embodiment of the inventive concept, a display device includes: a case part; a display panel unit (or display panel) in the case part, the display panel configured to provide an image; and an optical system in the case part, the optical system being spaced apart from the display panel in a first direction and having a focal point having a position which is periodically changed, wherein the image is periodically changed between a focused state and a defocused state.

In an embodiment, the optical system may be adapted to reciprocate in a direction parallel to the first direction.

In an embodiment, a focal length of the optical system may be periodically changed.

In an embodiment, the optical system may be adapted to contract and expand such that a thickness thereof in the first direction is changed.

In an embodiment, a refractive index of the optical system may be periodically changed.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a perspective view of a head-mounted device according to an embodiment of the inventive concept;

FIG. 2 is a view of a head-mounted device in use according to an embodiment of the inventive concept;

FIG. 3 is a partial exploded perspective view of a head-mounted device according to an embodiment of the inventive concept;

FIG. 4 is a schematic cross-sectional view of a head-mounted device according to an embodiment of the inventive concept;

FIG. 5 is a schematic cross-sectional view of a head-mounted device according to an embodiment of the inventive concept;

FIG. 6 is a schematic cross-sectional view of a head-mounted device according to an embodiment of the inventive concept;

FIG. 7 is a schematic cross-sectional view of a head-mounted device according to an embodiment of the inventive concept;

FIG. 8 is a schematic cross-sectional view of a head-mounted device according to an embodiment of the inventive concept;

FIG. 9 is a schematic cross-sectional view of a head-mounted device according to an embodiment of the inventive concept; and

FIG. 10 is a graph illustrating a change in a brightness level according to a positional change on a display panel unit according to an embodiment of the inventive concept.

### DETAILED DESCRIPTION

Hereinafter, example embodiments will be described in more detail with reference to the accompanying drawings. The inventive concept may be modified in many alternate forms, and thus specific embodiments will be exemplified in the drawings and described in detail. It should be understood, however, that it is not intended to limit the inventive concept to the particular form disclosed, but rather, and the inventive concept is to cover various modifications and equivalent arrangements included within the spirit and scope of the disclosure, including the appended claims and their equivalents. Accordingly, processes, elements, and techniques that are not necessary to those having ordinary skill in the art for a complete understanding of the aspects and features of the present invention may not be described. Also, parts in the drawings unrelated to the detailed description are omitted to ensure clarity of the present invention. Like reference numerals in the drawings denote like elements throughout. The relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and/or any other relevant devices or components according to embodiments of the present invention described herein (e.g., a display panel, a portable terminal, a driver, a controller, an optical system adjuster, a circuit layer, and/or a transistor) may be implemented utilizing any suitable hardware, firmware (e.g., an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

It should be understand that, as used herein, actions stated in the present or past tense (e.g., provides, provided, generates, generated, changes, changed, or the like) in reference to a device, component, or element mean that the referenced device, component, or element is structurally adapted to, configured to, or otherwise capable of performing the stated action unless the context clearly indicates otherwise. Thus, by way of example, a sentence such as “The display panel unit DU generates an image corresponding to input image data” should be understood to mean that the display panel unit DU is structurally adapted to, configured to, or otherwise capable of generating the image corresponding to the input image data and that, during operation, the display panel unit DU actually generates the image. Similarly, it should be understand that, as used herein, a device, component, or element described as being included or provided “for” the performance of stated action should be understood to mean that the described device, component, or element is structurally adapted to, configured to, or otherwise capable of performing the stated action unless the context clearly indicates otherwise. Thus, by way of example, a sentence such as “The case part 100 may receive therein (or include, coupled to, or engage with) a display panel unit (or display panel) for displaying an image, an acceleration sensor, and the like” should be understood to mean that the described display panel is structurally adapted to, configured to, or otherwise capable of displaying the image.

As used herein, a device, component, element, or point described as reciprocating or moving “between” two points should be understood to mean that the described device, component, element, or point may traverse the entire distance between the two points or may traverse only a portion of the distance between the two points. Thus, by way of example, a sentence such as “The optical system OL may reciprocate between the reference position SP and the user's eye US_E” should be understood to mean that the optical system OL may traverse the entire distance between the reference position SP and the user's eye US_E or the optical system OL may traverse only a portion of the distance between the reference position SP and the user's eye US_E.

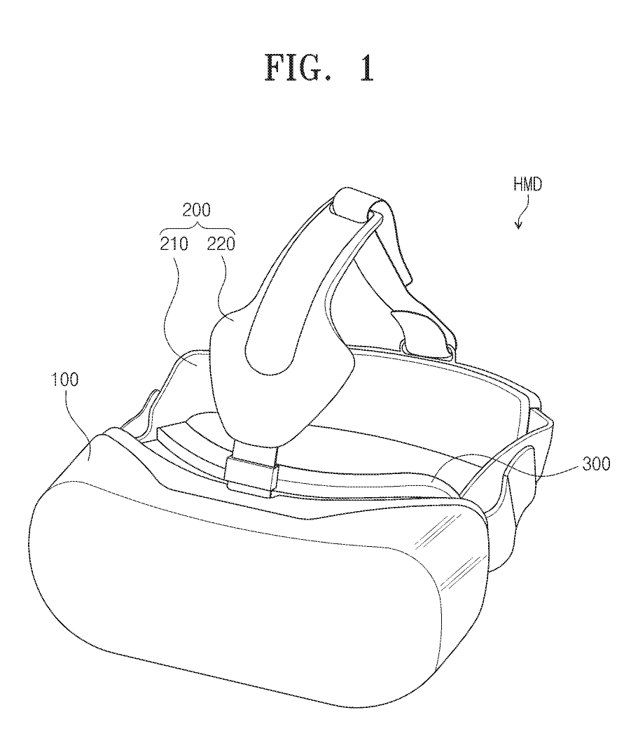

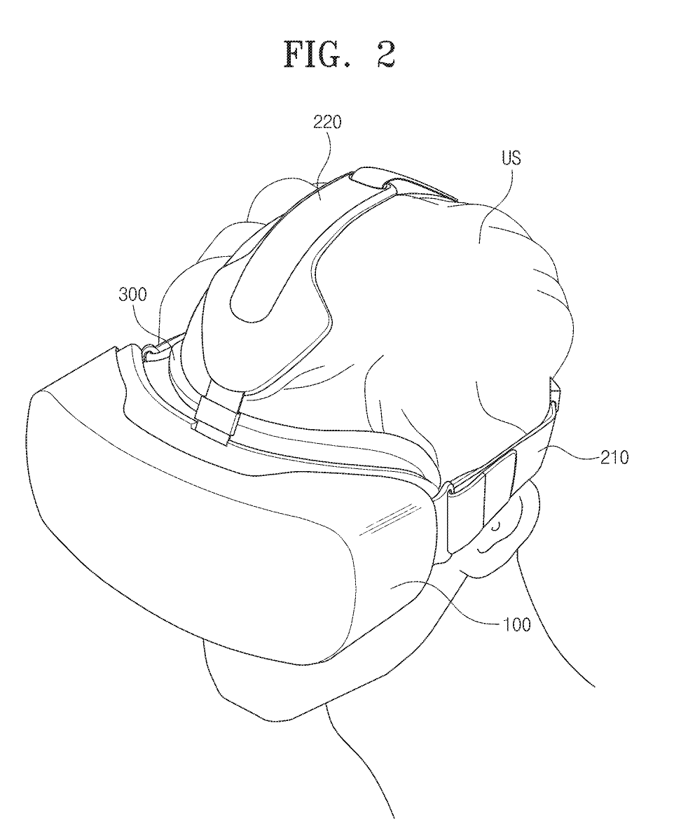

FIG. 1 is a perspective view of a head-mounted device according to an embodiment of the inventive concept, and FIG. 2 is a view of a head-mounted device in use according to an embodiment of the inventive concept.

Referring to FIGS. 1 and 2, in an embodiment a head-mounted device HMD is a device worn on a head of a user US. The head-mounted device HMD may provide the user US with an image (e.g., a textual and/or pictorial image) while blocking the actual (e.g., natural or unassisted) peripheral view of the user US. The user US wearing the head-mounted device HMD may be more easily immersed in virtual reality.

The head-mounted device HMD may include a case part 100, a strap part 200, and a cushion part 300.

The case part 100 may be worn on the head of the user US (as illustrated in FIG. 2, for example). The case part 100 may receive therein (or include, coupled to, or engage with) a display panel unit (or display panel) for displaying an image, an acceleration sensor, and/or the like. The acceleration sensor may detect a motion of the user US and transmit a signal (e.g., a predetermined signal) to the display panel unit. According to this, the display panel unit may provide an image corresponding to a change in a viewing line of the user US. Accordingly, the user US may experience virtual reality which is the same as actual reality.

The case part 100 may receive one or more components having various functions besides the above-described components. For example, the case part 100 may receive a proximity sensor for determining (e.g., detecting or sensing) whether the user US is wearing the head-mounted device HMD. Also, on an outer portion of the case part 100, an operation part for adjusting a sound volume and/or a brightness level of a screen may be additionally disposed. The operation part may be provided as a physical (e.g., movable) control apparatus (e.g., a button, a dial, a toggle, or a switch) or in a form that does not include a movable control apparatus, such as a touch sensor.

The strap part 200 is coupled to the case part 100 such that the case part 100 may be easily worn by the user US. The strap part 200 may include a main strap 210 and an upper end strap 220.

As illustrated in FIG. 2, in an embodiment the main strap 210 is worn along a circumference of the head of the user US. The main strap 210 may promote a fixed (or firm or steady) engagement of the case part 100 to the user US such that the case part 100 contacts (e.g., closely contacts) the head of the user US. The upper end strap 220 may connect the case part 100 to the main strap 210 along an upper head portion of the user US. The upper end strap 220 may prevent the case part 100 from being loosened down (e.g., from sliding down a face of the user US as a result of the main strap 210 becoming loosened). Also, the upper end strap 220 may improve a wearing feeling of the user US (e.g., a level of comfort, snugness, stability, and/or ergonomics) by distributing a load of the case part 100.

FIG. 1 illustrates an example shape in which respective lengths of the main strap 210 and the upper end strap 220 are adjustable, but the embodiment of the inventive concept is not limited thereto. For example, in an embodiment, the main strap 210 and the upper end strap 220 have elasticity in place of or in combination with having a portion with a length which is adjustable.

In promoting a fixed (or firm or steady) engagement between the case part 100 and the user US, the strap part 200 may be modified into various shapes besides the shapes illustrated in FIGS. 1 and 2. For example, in another embodiment of the inventive concept, the upper end strap 220 may not be provided (i.e., may be omitted). Also, in another embodiment of the inventive concept, the strap part 200 may be modified in various shapes such as a helmet coupled to the case part 100, or eyeglass temples coupled to the case part 100.

The cushion part 300 may be disposed (or positioned, arranged, or located) between the case part 100 and the head of the user US. The cushion part 300 may be partially or entirely formed of a material having a shape which may be transformed (e.g., freely transformed). For example, the cushion part 300 may be formed partially or entirely of a polymer resin (e.g., polyurethane, polycarbonate, polypropylene, polyethylene, any other suitable polymer resin known to those skilled in the art, or a combination thereof) or may be partially or entirely formed of sponges partially or entirely formed of rubber liquid, urethane-based materials, acryl-based materials, any other suitable material known to those skilled in the art, or a combination thereof. However, the embodiment of the inventive concept is not limited thereto.

The cushion part 300 allows the case part 100 to closely contact the user US and may thereby improve a wearing feeling of the user US. The cushion part 300 may be detached from the case part 100. In another embodiment of the inventive concept, the cushion part 300 may not be provided.

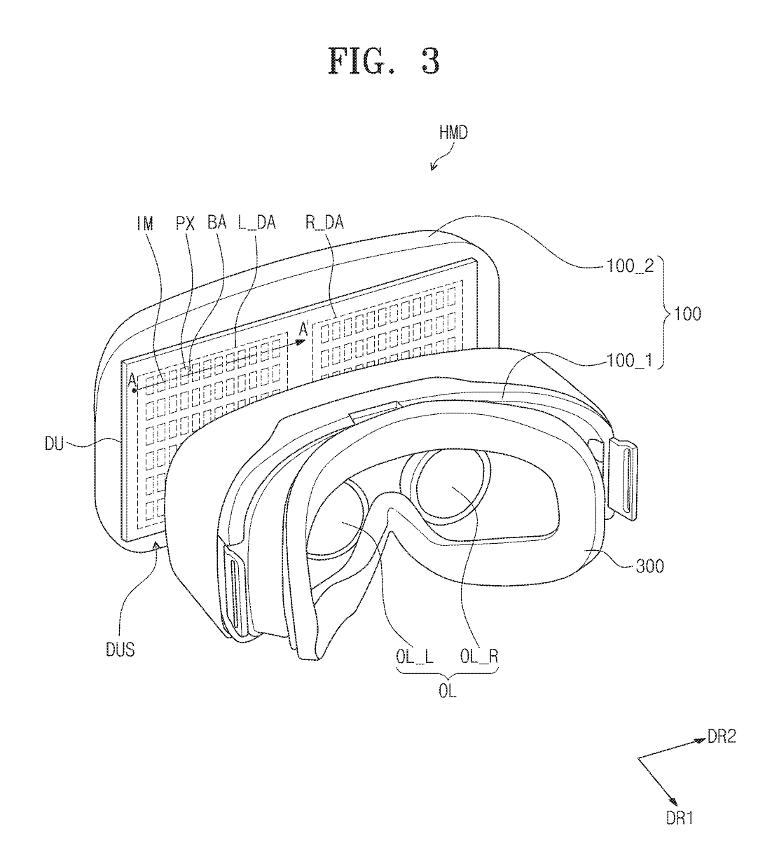

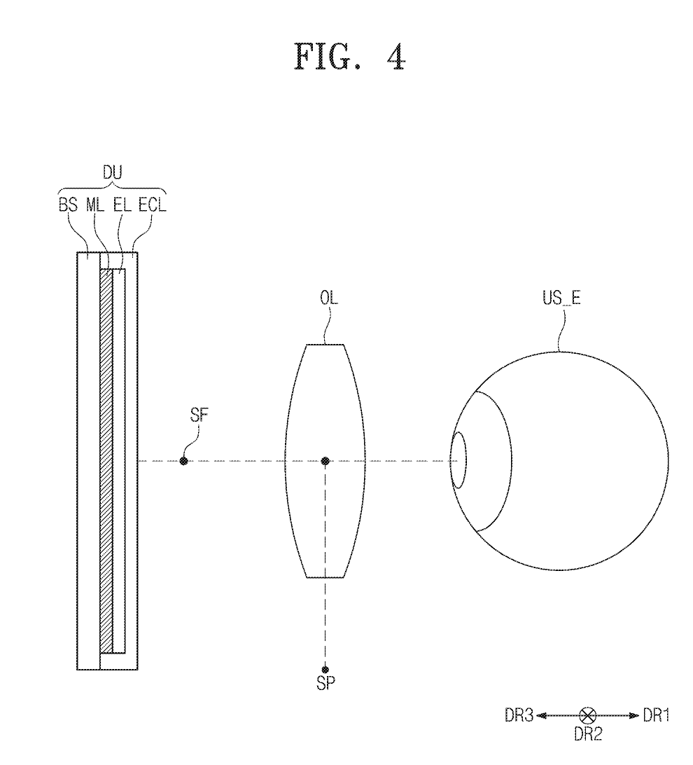

FIG. 3 is a partial exploded perspective view of a head-mounted device according to an embodiment of the inventive concept, and FIG. 4 is a schematic cross-sectional view of a head-mounted device in use according to an embodiment of the inventive concept. FIG. 3 does not illustrate the configuration of a strap part (e.g., the strap part 200 illustrated in FIG. 1). Also, FIG. 4 does not illustrate configurations other than a display panel unit DU, an optical system OL, and a user's eye US_E.

Referring to FIGS. 3 and 4, in an embodiment a case part 100 is separated into a body part 100_1 and a cover part 100_2. A mounting space DUS for a display panel unit is provided (or located) between the body part 100_1 and the cover part 100_2, and the cover part 100_2 may at least partially cover the mounting space DUS. FIG. 3 illustrates an example shape (or configuration) in which the body part 100_1 and the cover part 100_2 are separated, but an embodiment of the inventive concept is not limited thereto. For example, the body part 100_1 and the cover part 100_2 may be integrally formed or provided and may not be separable from each other.

The display panel unit DU is disposed in the mounting space DUS between the body part 100_1 and the cover part 100_2. The display panel unit DU may be integrally embedded in the head-mounted device HMD to provide (e.g., generate, display, and/or transmit) an image. However, the embodiment of the inventive concept is not limited thereto. For example, a display device (e.g., a portable terminal) including the display panel unit DU may also be coupled to the head-mounted device HMD to provide an image.

Referring to FIG. 3, an example embodiment in which a left eye image and a right eye image are displayed through one (e.g., a common) display panel unit DU is described. The display panel unit DU may be divided into a left eye image display region L_DA in which the left eye image is displayed and a right eye image display region R_DA in which the right eye image is displayed. The left eye image display region L_DA and the right eye image display region R_DA may be driven by separate drive parts (or drivers). However, the embodiment of the inventive concept is not limited thereto, and both the left eye image display region L_DA and the right eye image display region R_DA may be driven by one drive part. Also, in an embodiment of the inventive concept, the display panel unit DU may include a left eye display panel unit and a right eye display panel unit which are separated from each other.

The display panel unit DU generates an image corresponding to input image data. The display panel unit DU may include any one of an organic light emitting display panel, a liquid crystal display panel, a plasma display panel, an electrophoretic display panel, an electro-wetting display panel, or any other suitable display panel known to those of ordinary skill in the art. Although an example embodiment is described wherein the display panel unit DU includes an organic light emitting display panel, an embodiment of the inventive concept is not limited thereto.

As illustrated in FIG. 4, in an embodiment the display panel unit DU includes a base substrate BS, a circuit layer ML, an organic light emitting element layer EL, and an encapsulation layer ECL.

The base substrate BS may include at least any one of a glass substrate, a sapphire substrate, a plastic substrate, any other suitable substrate known to those of ordinary skill in the art, or a combination thereof. The circuit layer ML, the organic light emitting element layer EL, and the encapsulation layer ECL may be disposed on the base substrate BS.

The circuit layer ML may include a plurality of signal lines and/or electronic elements. For example, the circuit layer ML may include gate lines, data lines, and/or thin film transistors each corresponding to each of a plurality of pixels.

The organic light emitting element layer EL may include an organic light emitting layer formed of a low molecular weight material and/or a high molecular weight material. The organic light emitting layer may emit light. As persons of ordinary skill in the art will readily recognize and appreciate, the organic light emitting element layer EL may include (e.g., selectively include) a hole transport layer HTL, a hole injection layer HIL, an electron transport layer ETL, and/or an electron injection layer EIL, and/or the like in addition to the light emitting layer.

The encapsulation layer ECL may include a thin film encapsulation (TFE), that is, a plurality of inorganic thin films and/or a plurality of organic thin films. As illustrated in FIG. 4, in an embodiment the encapsulation layer ECL covers the organic light emitting element layer EL and may protect the organic light emitting element layer EL by blocking air and/or water. In an embodiment of the inventive concept, the encapsulation layer ECL may be replaced with an encapsulation substrate. The encapsulation substrate may be spaced apart from the base substrate BS with the organic light emitting element layer EL therebetween. The encapsulation substrate and the base substrate BS may be coupled to each other by a sealing agent disposed along the periphery of the base substrate BS or any other suitable coupling mechanism or agent known to those of ordinary skill in the art.

An optical system OL may be disposed in the body part 100_1 of the case part 100. The optical system OL may be (or have or include) a convex-shape aspherical lens. In an embodiment, the optical system OL may be (or have or include) a suitable lens (e.g., convex lens, integrated lens combined with various lens) known to those of ordinary skill in the art other than a convex-shape aspherical lens. The optical system OL may expand the image provided from the display panel unit DU. The optical system OL may be spaced apart from the display panel unit DU in a first direction DR1. The optical system OL may be disposed between the display panel unit DU and the user's eye US_E.

As illustrated in FIG. 3, in an embodiment the optical system OL may include a right eye optical system OL_R and a left eye optical system OL_L. The left eye optical system OL_L expands and provides an image to a left pupil of the user (user US in FIG. 2, for example), and the right eye optical system OL_R expands and provides an image to a right pupil of the user (user US in FIG. 2, for example).

The left eye optical system OL_L and the right eye optical system OL_R may be spaced apart from each other in a second direction DR2 crossing (e.g., perpendicular to) the first direction DR1. A distance between the right eye optical system OL_R and the left eye optical system OL_L (e.g., a distance measured in the second direction D2) may be adjusted to correspond to a distance between the two eyes US_E of the user US (user US in FIG. 2, for example).

A distance between the optical system OL and the display panel unit DU (e.g., a distance measured in the third direction D3) may be adjusted according to (e.g., to accommodate or account for) the eyesight of the user (user US in FIG. 2, for example). As the position of the optical system OL is adjusted, the adjustment may cause a position of a focal point SF of the optical system OL to be changed. For example, the user US may focus the image provided from the display panel unit DU by adjusting the position of the optical system OL. Hereinafter, the position of the optical system OL at which an image is focused is defined as a reference position SP.

In an embodiment, the position of the optical system OL may be changed or adjusted (e.g., periodically changed or adjusted, or changed or adjusted according to a defined period or interval) with respect to the reference position SP. Accordingly, the position of the focal point SF of the optical system OL may also in turn be changed or adjusted (e.g., periodically changed or adjusted). For example, a number of reciprocations in which the position of the focal point SF returns to one point (e.g., a first point or an origin point) again after being moved from the one point to another point (e.g., a second point or a destination point) for a time period or interval (e.g., one second) may be greater than or equal to a critical fusion frequency (CFF). For example, when the critical fusion frequency is 60 Hz, the number of reciprocations may be about 60 or more. However, an embodiment of the inventive concept is not limited thereto, and the number of reciprocations may be manipulated (e.g., arbitrarily manipulated) by the user (user US in FIG. 2, for example). The critical fusion frequency is a minimum frequency such that when two kinds of light different from each other alternately flicker, the flickering may not be sensed (e.g., visually perceived) by the user because each of the lights is instead perceived or recognized as always (or continuously) turned on.

As the position of the focal point SF of the optical system OL is changed or adjusted (e.g., periodically changed or adjusted), the optical system OL may function as a spatial frequency filter. More specifically, the optical system OL may be or may function as a low pass filter passing an image having a spatial frequency of a low frequency band. Referring to FIG. 3, in an embodiment a non-pixel region BA in which no image is displayed may be defined between or among a plurality of pixels PX. The pixels PX may be spaced apart from each other with the non-pixel region BA therebetween. When the spatial frequency of the pixels PX and the non-pixel region BA are defined as a first spatial frequency, the spatial frequency of the image displayed on the display panel unit DU may be lower than the first spatial frequency. As the position of the focal point SF of the optical system OL is changed or adjusted (e.g., periodically changed or adjusted), an image may be defocused (e.g., periodically defocused). As a result, a contrast ratio between the pixels PX and the non-pixel region BA is decreased, and thus a probability that the border among the pixels PX, that is, the non-pixel region BA, is viewable by the user (user US in FIG. 2, for example) may be decreased, minimized, and/or eliminated.

FIG. 3 illustrates an embodiment in which the pixels PX are disposed or arranged with respect to each other in a matrix shape while having rectangular shapes, but an embodiment of the inventive concept is not limited thereto. For example, the shapes of the pixels PX may be variously modified to form polygons, circles, ellipses, or any other suitable shape known to those of ordinary skill in the art. Also, the pixels PX may be disposed or arranged with respect to each other in various shapes or arrangements in addition to or in place of the matrix shape.

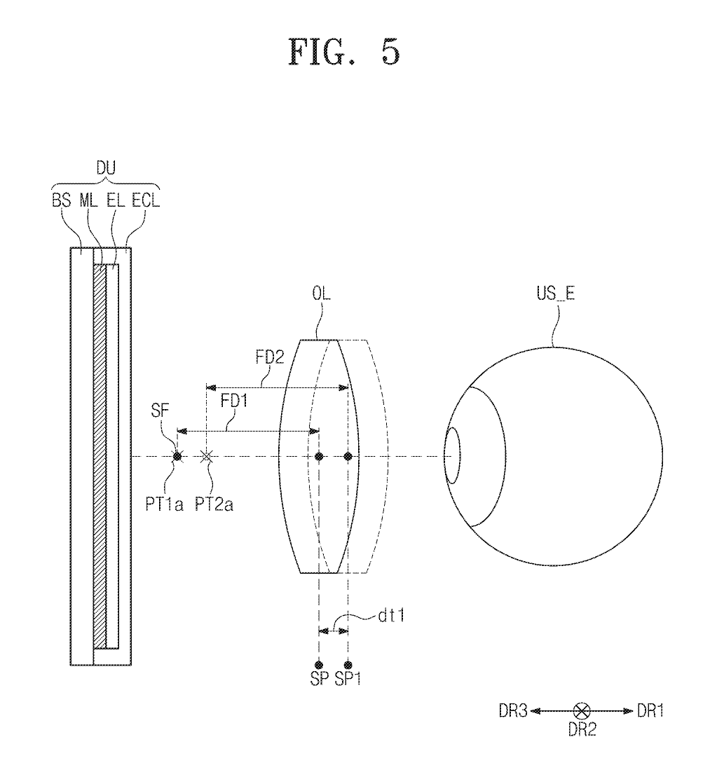

FIG. 5 is a schematic cross-sectional view of a head-mounted device according to an embodiment of the inventive concept.

Referring to FIGS. 3 and 5, an optical system OL may reciprocate in a direction parallel to a first direction DR1. For example, the optical system OL may reciprocate in or between the first direction DR1 and a third direction DR3 which is opposite to the first direction DR1.

The optical system OL may repeat a motion in which the optical system OL returns to a reference position SP after being moved to a first position SP1 which is spaced apart from the reference position SP by a first distance dt1 in the first direction DR1. That is, the optical system OL may reciprocate between the reference position SP and the user's eye US_E. A user (user US in FIG. 2, for example) may adjust (e.g., arbitrarily adjust) the first distance dt1. The greater the first distance dt1, the stronger a degree of defocusing of an image may be. Accordingly, the user (user US in FIG. 2, for example) may adjust the first distance dt1 at a level in which a plurality of details of an image are not decreased (e.g., at a level in which there is no perceptible loss of sharpness or resolution) even while the non-pixel region BA is not viewed, perceived, sensed, or detected.

As the position of the optical system OL is adjusted, the position of the focal point SF of the optical system OL may be changed. For example, the position of the focal point SF may be changed between a first point PT1a and a second point PT2a. The first point PT1a may be a position of the focal point SF when the optical system OL is positioned at the reference position SP, and the second point PT2a may be a position of the focal point SF when the optical system OL is positioned at the first position SP1.

Because the optical system OL is moved, the position of the focal point SF is changed, but focal lengths FD1 and FD2 may remain unchanged. That is, the focal length FD1 when the optical system OL is positioned at the reference position SP and the focal length FD2 when the optical system OL is positioned at the first position SP1 may be the same as each other (i.e., equal).

The position of the focal point SF may be changed or adjusted (e.g., periodically changed or adjusted) between a first point PT1a at which an image is focused and a second point PT2a at which the image is defocused. As images are periodically defocused, the contrast ratio between the pixels PX and the non-pixel region BA may be decreased. As a result, the probability that borders between the pixels PX, that is, the non-pixel region BA, may be viewed (e.g., visually perceived) by the user (user US in FIG. 2, for example) may be decreased, minimized, and/or eliminated.

Although not illustrated in FIG. 5, the head-mounted device HMD may further include an optical system adjuster adapted to control a position of the optical system OL and a control unit (or controller) for controlling the optical system adjuster. For example, the control unit may control the optical system adjuster on the basis of input signals from the user or one or more preset signals. The control unit may transmit periodical signals (e.g., signals having frequencies greater than a critical frequency) to the optical system adjuster. The optical system adjuster may be connected (e.g., physically, operably, and/or communicatively connected) to the optical system OL to adjust the position of the optical system OL. The optical system adjuster may include an element capable of converting an electrical signal such as a signal of an electrically driven device or a piezoelectric element into a mechanical movement (e.g., a transducer or a converted).

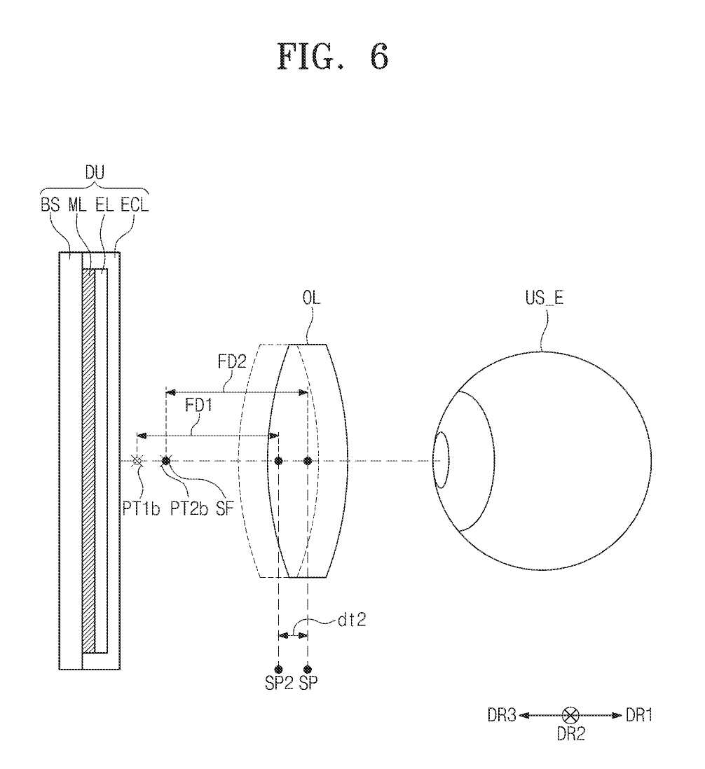

FIG. 6 is a schematic cross-sectional view of a head-mounted device according to an embodiment of the inventive concept. FIG. 6 is different from FIG. 5 with respect to an interval (e.g., a spatial interval) in which an optical system OL is moved.

Referring to FIG. 6, an optical system OL may reciprocate in the direction parallel to the first direction DR1. For example, the optical system OL may repeat a motion in which the optical system OL returns (e.g., automatically returns) to a reference position SP after being moved to a second position SP2 which is spaced apart from the reference position SP by a second distance dt2 in the third direction DR3. That is, the optical system OL may reciprocate between a display panel unit DU and the reference position SP.

As the position of the optical system OL is changed, the position of the focal point SF of the optical system OL may also be changed. For example, the position of the focal point SF may be changed between a first point PT1b and a second point PT2b. The first point PT1b may be a position of the focal point SF when the optical system OL is positioned at the second position SP2, and the second point PT2b may be a position of the focal point SF when the optical system OL is positioned at the reference position SP.

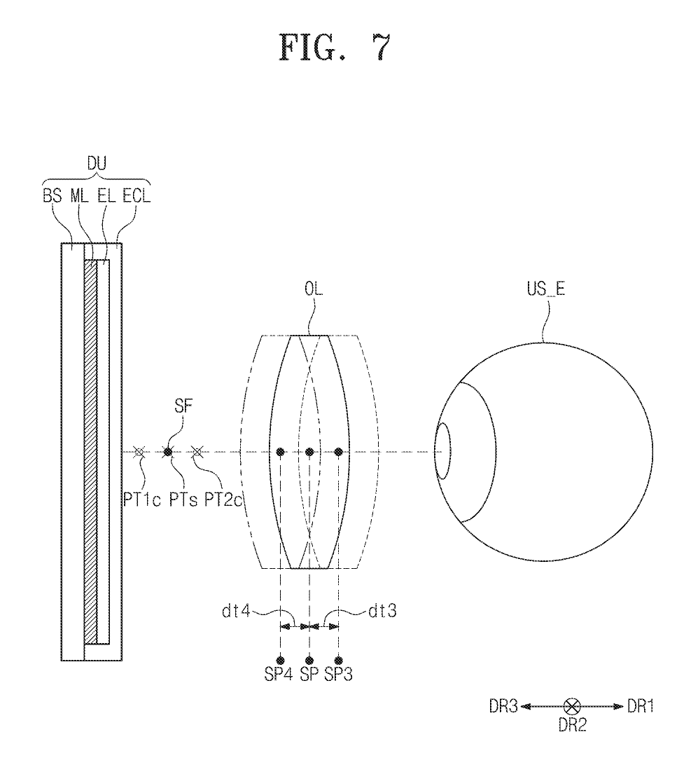

FIG. 7 is a schematic cross-sectional view of a head-mounted device according to an embodiment of the inventive concept. FIG. 7 is different from FIGS. 5 and 6 with respect to an interval (e.g., a spatial interval) in which an optical system OL is moved.

Referring to FIG. 7, an optical system OL may reciprocate in the direction parallel to the first direction DR1. For example, the optical system OL may reciprocate between a third position SP3, which is spaced apart from a reference position SP by a third distance dt3 in the first direction DR1, and a fourth position SP4 which is spaced apart from the reference position SP by a fourth distance dt4 in the third direction DR3.

As the position of the optical system OL is changed, the position of a focal point SF may also be changed between the first point PT1c and the second point PT2c. The first point PT1c may be a position of the focal point SF when the optical system OL is positioned at the fourth position SP4, and the second point PT2c may be a position of the focal point SF when the optical system OL is positioned at the third position SP3. A point PTs between the first point PT1c and the second point PT2c is a position of the focal point when the optical system OL is at the reference position SP.

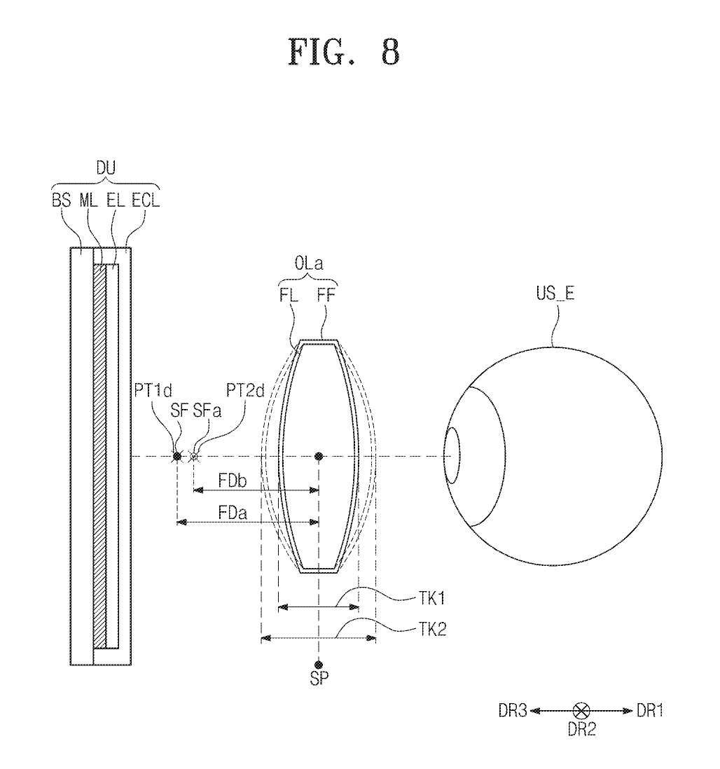

FIG. 8 is a schematic cross-sectional view of a head-mounted device according to an embodiment of the inventive concept.

Referring to FIG. 8, the position of an optical system OLa is fixed at a reference position SP. The reference position SP may be adjusted in a direction that crosses (e.g., is perpendicular to) the first direction D1, the second direction D2, and/or the third direction D3 to correspond to (e.g., to match) an eyesight of the user's eye US_E. However, an embodiment of the inventive concept is not limited thereto, and the reference position SP may also be fixed (or nonadjustable).

The thickness of the optical system OLa in the first direction DR1 may be changed or adjusted (e.g., periodically changed or adjusted). For example, after the thickness of the optical system OLa is changed from a first thickness TK1 to a second thickness TK2, contraction and expansion movements in which the second thickness TK2 is changed again to the first thickness TK1 may be repeated.

As the thickness of the optical system OLa is changed, a radius of curvature of the optical system OLa is changed. As the radius of curvature of the optical system OLa is changed, the focal length of the optical system OLa may be changed. For example, when the optical system OLa has the first thickness TK1, the optical system OLa may have a first focal length FDa, and when the optical system OLa has the second thickness TK2, the optical system OLa may have a second focal length FDb.

The radius of curvature of the optical system OLa when the optical system OLa has the second thickness TK2 is smaller than that of the optical system OLa when the optical system OLa has the first thickness TK1. Accordingly, the first focal length FDa may be greater than the second focal length FDb.

The position of the focal point SF of the optical system OLa may be changed between a first point PT1d and a second point PT2d. The first point PT1d may be a position of the focal point SF when the optical system OLa has the first thickness TK1, and the second point PT2d may be a position of the focal point SFa when the optical system OLa has the second thickness TK2.

The thickness of the optical system OLa may be adjusted through various methods. For example, the optical system OLa may include a film (or layer) FF and a fluid FL in (e.g., filling) the film FF. In an embodiment, the film FF has elasticity and may thereby be contracted or expanded according to the amount of the fluid FL. Thus, the thickness of the optical system OLa may be adjusted by adjusting the amount of the fluid FL. However, an embodiment of the inventive concept is not limited thereto. For example, in an embodiment of the inventive concept, the optical system OLa may include an electroactive polymer having a shape which is deformed when a voltage is applied to the electroactive polymer. The electroactive polymer may have a property or characteristic of contracting when electrified. Accordingly, the thickness of the optical system OLa may be adjusted by applying (e.g., periodically applying) a voltage to the optical system OLa.

FIG. 8 illustrates an embodiment wherein when the optical system OLa has the first thickness TK1, an image is focused, and when the optical system OLa has the second thickness TK2, the image is defocused. The positions of the focal points SF and SFa may be changed or adjusted (e.g., periodically changed or adjusted) between a first point PT1d at which an image is focused and a second point PT2d at which the image is defocused. Thus, the focused image and the defocused image may be alternately provided (or displayed) to a user. The borders between the pixels PX and the non-pixel region BA may become unclear due to a defocused state in which an image focus is unclear. Accordingly, a phenomenon in which the non-pixel region BA is viewable (e.g., visibly perceptible) may be reduced, minimized, and/or prevented.

In an embodiment of the inventive concept, when the optical system OLa has the second thickness TK2, the image may also be focused, and when the optical system OLa has a thickness (e.g., a predetermined thickness) between the first thickness TK1 and the second thickness TK2, the image may also be focused.

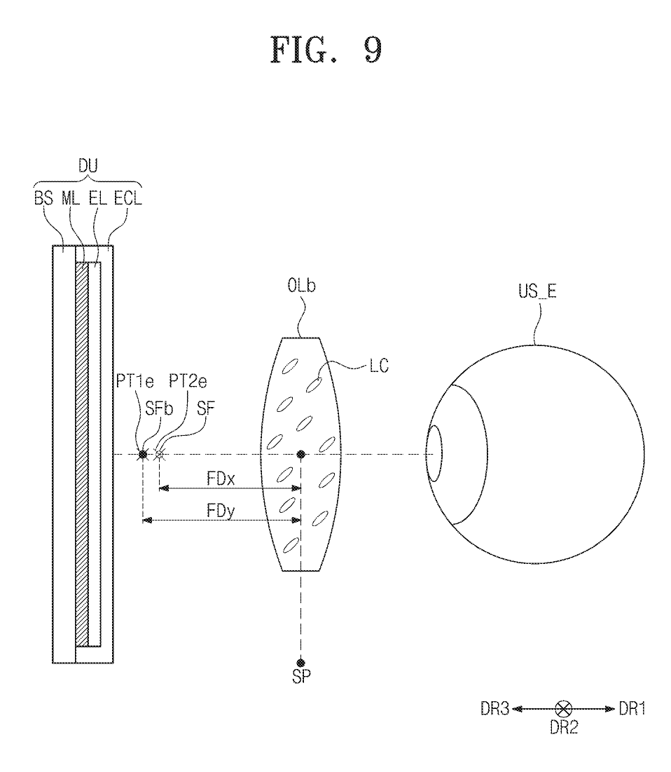

FIG. 9 is a schematic cross-sectional view of a head-mounted device according to an embodiment of the inventive concept.

Referring to FIGS. 3 and 9, the position of an optical system OLb is fixed at a reference position SP. In an embodiment, the refractive index of the optical system OLb may be changed. As the refractive index of the optical system OLb is changed, a plurality of focal lengths FDx and FDy may also be changed or adjusted.

The optical system OLb may include a plurality of liquid crystal molecules LC having varying orientation directions. A voltage (e.g., a predetermined voltage) may be applied to the optical system OLb, and the orientation directions of the liquid crystal molecules LC may be changed or adjusted according to one or more voltage differences. As a result, the refractive index of the optical system OLb may be changed or adjusted.

When the optical system OLb has a first refractive index, the optical system OLb has a first focal length FDx, and when the optical system OLb has a second refractive index, the optical system OLb has a second focal length FDy. The first refractive index may be greater than the second refractive index, and the first focal length FDx may be smaller than the second focal length FDy.

When the optical system OLb has the first focal length FDx, the focal point SF is positioned at a second point PT2e, and when the optical system OLb has the second focal length FDy, the focal point SFb may be positioned at a first point PT1e. As the refractive index of the optical system OLb is changed or adjusted (e.g., periodically changed or adjusted), one or more focused images and defocused images are alternately provided to a user. Thus, the borders between the pixels PX and the non-pixel region BA may become unclear (e.g., having a degree of sharpness or resolution loss such that the borders are unlikely to be visually perceived by a human user) due to a defocused state in which an image focus is unclear. Accordingly, the phenomenon in which the non-pixel region BA is viewable (e.g., visually perceptible) may be reduced, minimized, and/or prevented.

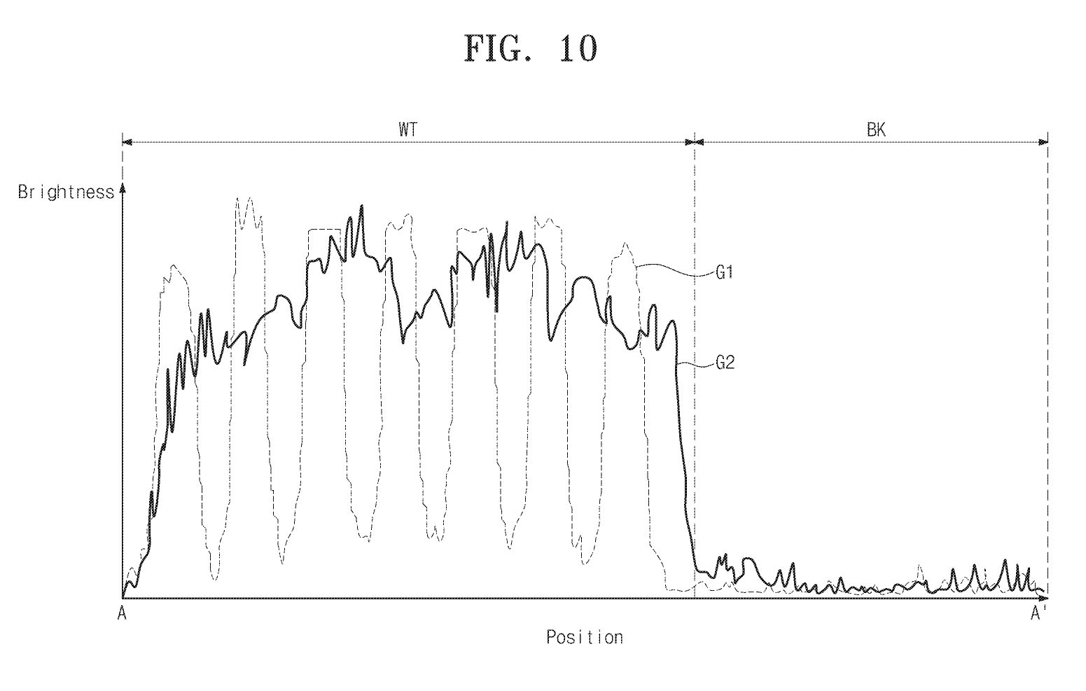

FIG. 10 is a graph illustrating a change in a brightness level according to a positional change on a display panel unit according to an embodiment of the inventive concept.

More particularly, FIG. 10 is a graph schematically illustrating a brightness change measured along an imaginary straight line IM which extends from a point A on the display panel unit DU of FIG. 3 toward another point A′.

Referring to FIGS. 3, 4, and 10, a first graph G1 is a graph in which a brightness change of the display panel unit DU is measured when the position of the focal point SF of the optical system OL is fixed, and a second graph G2 is a graph in which a brightness change of the display panel unit DU is measured when the position of the focal point SF of the optical system OL is changed or adjusted (e.g., periodically changed or adjusted). The position of the focal point SF may be changed or adjusted (e.g., periodically changed or adjusted) in a direction parallel to the first direction DR1. For example, a number of reciprocations in which the position of the focal point SF is moved from a point (e.g., a predetermined point) in the first direction DR1 for a time period or interval (e.g., one second), is then moved in the third direction DR3, and then returns to the point (e.g., the predetermined point) may be about 60 or more. However, this is only an example, and the number of reciprocations may be variously changed (i.e., may be higher or lower than about 60 reciprocations).

A first image WT and a second image BK may be alternately displayed along an imaginary straight line IM on the display panel unit DU. Each of the first image WT and the second image BK may be displayed by a plurality of pixels PX (e.g., the pixels PX illustrated in FIG. 3). For example, the first image WT may be a white image, and the second image BK may be a black image. Thus, all pixels PX disposed on a region on which the first image WT is displayed may provide light, and all pixels PX disposed on a region on which the second image BK is displayed may not provide light.

In a region on which the first image WT of the first graph G1 according to a comparative example is displayed, the region corresponding to the positions of the pixels PX may have relatively high brightness, and the region corresponding to the non-pixel region BA may have a relatively low brightness. Because the image provided from the display panel unit DU is expanded by the optical system OL, the expanded image, in which not only pixels PX but also the non-pixel region BA are expanded together, is provided to a user. That is, as the non-pixel region BA is expanded, the non-pixel region BA may be viewed (e.g., easily viewed or visibly perceived) by the user, and as a result, the display quality of the head-mounted device may deteriorate.

In the second graph G2 according to an embodiment of the inventive concept, the position of the focal point SF of the optical system is changed or adjusted (e.g., periodically changed or adjusted). Accordingly, an image provided from the display panel unit DU is changed or adjusted (e.g., periodically changed or adjusted) from a focused state into a defocused state. As the focused and defocused states are repeated, a brightness difference between a first region corresponding to the positions of the pixels PX and a second region corresponding to the non-pixel region BA may be reduced. Accordingly, the probability that the non-pixel region BA is viewable (e.g., visibly perceptible) by the user may be reduced, minimized, and/or eliminated and, as a result, the display quality of the head-mounted device HMD may be improved.

According to an embodiment of the inventive concept, one or more images are defocused (e.g., periodically defocused) so that the phenomenon in which a non-pixel region is expanded to be viewable (e.g., visually perceptible) by a user may be reduced, minimized, and/or prevented.

It will be apparent to those skilled in the art that various modifications and variations can be made in the inventive concept. Thus, it is intended that the inventive concept covers the modifications and variations of this disclosure provided they come within the scope of the appended claims and their equivalents. Therefore, the scope of the inventive concept is defined not by the detailed description of the inventive concept but by the appended claims and their equivalents.

What is claimed is:

1. A head-mounted device, comprising:
a case part comprising a body part and a cover part configured to cover at least a portion of the body part, wherein a space for mounting a display panel is between the body part and the cover part; and
an optical system positioned in the body part to face the cover part and having a focal point having a position which is periodically changed.

2. The head-mounted device of claim 1, wherein the optical system is spaced apart from the cover part in a first direction, and the position of the focal point is periodically changed between a first point and a second point spaced apart from the first point in the first direction.

3. The head-mounted device of claim 2, wherein a number of times that the position of the focal point is changed from the first point to the second point for about one second and then returned to the first point is greater than a critical fusion frequency (CFF).

4. The head-mounted device of claim 2, wherein a number of times that the position of the focal point is changed from the first point to the second point for about one second and then returned to the first point is changeable according to a user request.

5. The head-mounted device of claim 2, wherein the optical system is adapted to reciprocate in a direction parallel to the first direction.

6. The head-mounted device of claim 5, wherein while the optical system reciprocates, a focal length of the optical system is invariant.

7. The head-mounted device of claim 2, wherein a focal length of the optical system is periodically changed.

8. The head-mounted device of claim 7, wherein the optical system is adapted to contract and expand such that a thickness thereof in the first direction is changed.

9. The head-mounted device of claim 8, wherein the optical system comprises an electroactive polymer having a shape which is deformed when a voltage is applied to the electroactive polymer.

10. The head-mounted device of claim 8, wherein the optical system comprises a film and a fluid in the film, wherein a thickness of the optical system in the first direction is changeable by adjusting the amount of the fluid.

11. The head-mounted device of claim 7, wherein a refractive index of the optical system is periodically changed.

12. The head-mounted device of claim 11, wherein the optical system comprises a plurality of liquid crystal molecules having varying orientation directions, wherein the refractive index of the optical system is changeable according to the orientation directions of the liquid crystal molecules.

13. The head-mounted device of claim 2, further comprising a display panel in the space for mounting the display panel, wherein the display panel is configured to provide an image.

14. The head-mounted device of claim 13, wherein when the position of the focal point is at any one of the first point and the second point, the image is focused.

15. The head-mounted device of claim 13, wherein when the position of the focal point is at one point between the first point and the second point, the image is focused.

16. A display device, comprising:
a case part;
a display panel in the case part, the display panel configured to provide an image; and
an optical system in the case part, the optical system spaced apart from the display panel in a first direction and having a focal point having a position which is periodically changed,
wherein the image is periodically changed between a focused state and a defocused state.

17. The display device of claim 16, wherein the optical system is adapted to reciprocate in a direction parallel to the first direction.

18. The display device of claim 16, wherein a focal length of the optical system is periodically changed.

19. The display device of claim 18, wherein the optical system is adapted to contract and expand such that a thickness thereof in the first direction is changed.

20. The display device of claim 18, wherein a refractive index of the optical system is periodically changed.
